(19) United States
(12) Patent Application Publication
(10) Pub. No.: US 2023/0084969 A1
(43) Pub. Date: Mar. 16, 2023

(54) DATABASE SYSTEM, DATABASE MANAGEMENT METHOD, AND NON-TRANSITORY COMPUTER-READABLE MEDIUM STORING PROGRAM

(71) Applicant: NEC Corporation, Minato-ku, Tokyo (JP)

(72) Inventor: Saeka HOMMA, Tokyo (JP)

(73) Assignee: NEC Corporation, Minato-ku, Tokyo (JP)

(21) Appl. No.: 17/801,315

(22) PCT Filed: Mar. 4, 2020
(86) PCT No.: PCT/JP2020/009269

§ 371 Date: Aug. 22, 2022

(51) Int. Cl. G06F 21/62

(52) U.S. Cl. CPC G06F 21/6218

(57) ABSTRACT

A database system (100) that can detect unauthorized access more quickly with simpler process steps is provided. The database system includes an unauthorized access target determination unit (102) configured to determine, when there is an access request, whether or not the access request is an access request to an unauthorized access target data, by comparing information included in the access request, and unauthorized access target information concerning the unauthorized access target data requiring protection from unauthorized access, an access pattern determination unit (103) configured to determine whether or not the access request is unauthorized access, by comparing information included in the access request, and an access pattern table concerning an access pattern of a user having access authority to the unauthorized access target data, and an alert notification unit (105) configured to perform an alert notification to a predetermined notification destination when the access request is unauthorized access.

### TECHNICAL FIELD

The present invention relates to a database system, a database management method, and a non-transitory computer-readable medium storing a program.

### BACKGROUND ART

As a first method of dealing with a leakage of the data stored in a database system, a method of restricting the use of the database system is known. Specifically, a user who can access the database system is registered in advance, and the authority for a table space of the database system is transferred to the registered user. Thereby, users who can access the data are limited.

For example, in Patent Literature 1, access plan information is created in advance, the created access plan information is registered in the database system, an approver approves the registered access plan information, and based on the approved access plan information, security policy information is generated. Patent Literature 1 indicates that with reference to the security policy information, abnormal access is detected from actual access record information of the database.

Further, as a second method, Non-Patent Literature 1 describes performing transparent data encryption (TDE: Transparent Data Encryption) in a database system. The transparent data encryption is a technology that encrypts data by using an encryption key (password) and stores the data in a table space of the database system, and decrypts the data by also using the encryption key when accessing the data.

Furthermore, as a third method, Patent Literature 2 describes dividing data to be stored in a database system into N data pieces, and storing the divided data in N databases.

### CITATION LIST

### Patent Literature

Patent Literature 1: Japanese Unexamined Patent Application Publication No. 2008-250728
Patent Literature 2: International Patent Publication No. WO2016/181904

### Non Patent Literature

Non-Patent Literature 1: Oracle Advanced Security, [online], [Searched on Nov. 25, 2019], The Internet <URL: http://www.oracle.com/jp/products/database/options/advanced-security/overview/index.html>

### SUMMARY OF INVENTION

### Technical Problem

However, in each of the first method and the method described in Patent Literature 1 described above, and the second method described above, access log information concerning the number of connections to the database system, the connection environment and the like is checked after the fact, and unauthorized access is detected. Therefore, there arises a problem that the leakage is noticed after the confidential information stored in the database system is leaked.

Further, in the aforementioned third method, it is necessary to divide the data into N data pieces when storing the data in the database system or updating the data stored in the database system. Further, it is necessary to read and decrypt the divided data from the N databases when referring to the data stored in the database system. Therefore, there is a problem that process steps at the times of storage, update and reference are numerous and complicated.

An object of the present invention is to provide a database system, a data management method, and a non-transitory computer-readable medium storing a program that can detect unauthorized access more quickly with simpler process steps.

### Solution to Problem

A database system according to a first aspect of the present invention includes unauthorized access target information storage means configured to store unauthorized access target information concerning an unauthorized access target data that is a data stored in a database and requires protection from unauthorized access, access pattern information storage means configured to store access pattern information concerning an access pattern to the unauthorized access target data by a user having access authority to the unauthorized access target data, unauthorized access target determination means configured to determine, when there is an access request to the data stored in the database, whether or not the access request is an access request to the unauthorized access target data, by comparing information included in the access request, and the unauthorized access target information stored in the unauthorized access target information storage means, access pattern determination means configured to determine whether or not the access request is unauthorized access, by comparing information included in the access request, and the access pattern information stored in the access pattern information storage means, when it is determined that the access request is the access request to the unauthorized access target data by the unauthorized access target determination means, access control means configured to provide the unauthorized access target data to the user, when it is determined that the access request is not unauthorized access by the access pattern determination means, and alert notification means configured to perform an alert notification to a predetermined notification destination, when it is determined that the access request is unauthorized access by the access pattern determination means.

In a database management method according to a second aspect of the present invention, a database system stores unauthorized access target information concerning an unauthorized access target data that is a data stored in a database and requires protection from unauthorized access, stores access pattern information concerning an access pattern to the unauthorized access target data by a user having access authority to the unauthorized access target data, determines, when there is an access request to the data stored in the database, whether or not the access request is an access request to the unauthorized access target data, by comparing information included in the access request, and the unauthorized access target information, determines whether or not the access request is unauthorized access, by comparing information included in the access request, and the access pattern information, when it is determined that the access request is the access request to the unauthorized access target data, provides the unauthorized access target data to the user when it is determined that the access request is not unauthorized access, and performs an alert notification to a predetermined notification destination when it is determined that the access request is unauthorized access.

A non-transitory computer-readable medium storing a database management program according to a third aspect of the present invention stores a database management program causing a database system to execute a process of storing unauthorized access target information concerning an unauthorized access target data that is a data stored in a database and requires protection from unauthorized access, a process of storing access pattern information concerning an access pattern to the unauthorized access target data by a user having access authority to the unauthorized access target data, a process of determining, when there is an access request to the data stored in the database, whether or not the access request is an access request to the unauthorized access target data, by comparing information included in the access request, and the unauthorized access target information, a process of determining whether or not the access request is unauthorized access, by comparing information included in the access request, and the access pattern information, when it is determined that the access request is the access request to the unauthorized access target data, a process of providing the unauthorized access target data to the user when it is determined that the access request is not unauthorized access, and a process of performing an alert notification to a predetermined notification destination when it is determined that the access request is unauthorized access.

### Advantageous Effects of Invention

The database system, the database management method, and the non-transitory computer-readable medium storing the program that can detect an unauthorized access more quickly with the simpler process steps can be provided.

### BRIEF DESCRIPTION OF DRAWINGS

FIG. 1 is a block diagram showing one example of a database system according to the present invention;

FIG. 2 is a block diagram showing one example of a database system according to a first example embodiment of the present invention;

FIG. 3 is a diagram showing one example of an unauthorized access target table that is registered in the database system according to the first example embodiment of the present invention;

FIG. 4 is a diagram showing one example of an access pattern table that is registered in the database system according to the first example embodiment of the present invention;

FIG. 5 is a flowchart showing one example of a database management method in the database system according to the first example embodiment of the present invention;

FIG. 6 is a flowchart explaining an unauthorized access detection process in step S103 in FIG. 5;

FIG. 7 is a diagram explaining the unauthorized access detection process in step S103 in FIG. 5;

FIG. 8 is a flowchart explaining an encryption process in step S104 in FIG. 5;

FIG. 9 is a diagram explaining one example of the encryption process in step S104 in FIG. 5;

FIG. 10 is a flowchart explaining an alert notification process in step S105 in FIG. 5;

FIG. 11 is a flowchart explaining a registration process of the unauthorized access target table to the database system according to the first example embodiment of the present invention;

FIG. 12 is a flowchart explaining the registration process of the unauthorized access target table to the database system according to the first example embodiment of the present invention;

FIG. 13 is a flowchart explaining a registration process of an access pattern table to the database system according to the first example embodiment of the present invention;

FIG. 14 is a diagram showing one example of an input form for registering the access pattern table to the database system according to the first example embodiment of the present invention;

FIG. 15 is a flowchart explaining the registration process of the access pattern table to the database system according to the first example embodiment of the present invention; and

FIG. 16 is a flowchart explaining the registration process of the access pattern table to the database system according to the first example embodiment of the present invention.

### EXAMPLE EMBODIMENT

Hereinafter, an embodiment of the present invention is described with reference to the drawings.

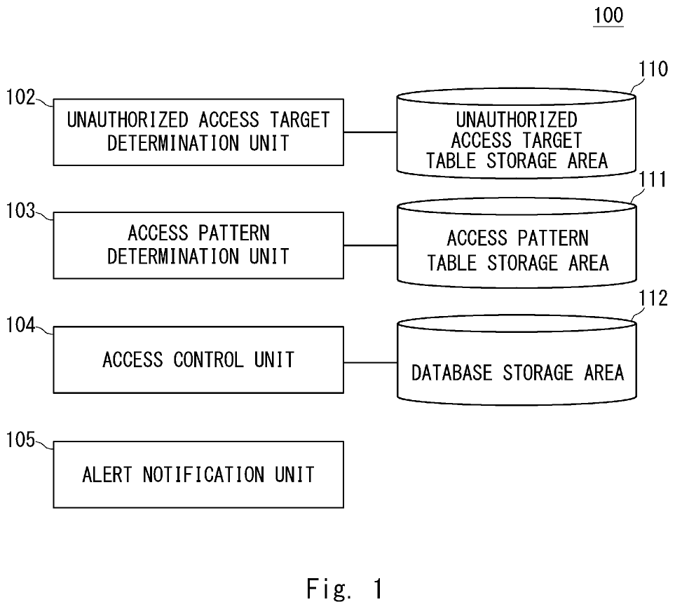

FIG. 1 is a block diagram showing one example of a database system 100 according to the present invention. As shown in FIG. 1, the database system 100 includes an unauthorized access target determination unit 102 as unauthorized access target determination means, an access pattern determination unit 103 as access pattern determination means, an access control unit 104 as access control means, an alert notification unit 105 as alert notification means, an unauthorized access target table storage area 110 as unauthorized access target information storage means, an access pattern table storage area 111 as access pattern information storage means, a database storage area 112 as a database and the like.

When there is an access request to data stored in the database storage area 112 of the database system 100, the unauthorized access target determination unit 102 compares information included in the access request, and unauthorized access target information stored in the unauthorized access target table storage area 110. Subsequently, the unauthorized access target determination unit 102 determines whether or not the access request is an access request to unauthorized access target data. Here, the unauthorized access target data is data that is stored in the database storage area 112 and requires protection from unauthorized access. Further, the unauthorized access target information is information concerning the unauthorized access target data. Specifically, the unauthorized access target information is a data name and the like of the unauthorized access target data.

The access pattern determination unit 103 compares information included in the access request and access pattern information stored in the access pattern table storage area 111 when it is determined that the above-described access request is the access request to the unauthorized access target data by the unauthorized access target determination unit 102. Subsequently, the access pattern determination unit 103 determines whether or not the access request is unauthorized access. Here, the access pattern information is information concerning an access pattern to the unauthorized access target data by a user having access authority to the unauthorized access target data. Specifically, the access pattern information is a name of the user having the access authority to the unauthorized access target data, a data name of the unauthorized access target data, an access date and time, and the like.

When it is determined that the above-described access request is not unauthorized access by the access pattern determination unit 103, the access control unit 104 provides the unauthorized access target data to the user.

The alert notification unit 105 performs an alert notification to a predetermined notification destination when it is determined that the above-described access request is unauthorized access by the access pattern determination unit 103.

According to the database system 100 according to the present invention described above, when there is an access request to the database storage area 112 of the database system 100, it is determined whether or not the access request is unauthorized access by the access pattern determination unit 103. Further, when it is determined that the access request is unauthorized access by the access pattern determination unit 103, an alert notification is performed to a predetermined notification destination by the alert notification unit 105. Therefore, it is possible to detect unauthorized access more quickly than checking access log information after the fact and then detecting the unauthorized access. Further, when data is stored in the database storage area 112 of the database system 100, it is not necessary to divide the data, and therefore, it is possible to decrease process steps at times of storage, update, and reference of the data more. Thereby, the database system 100 that can detect unauthorized access more quickly with the simpler process steps can be provided.

### First Example Embodiment

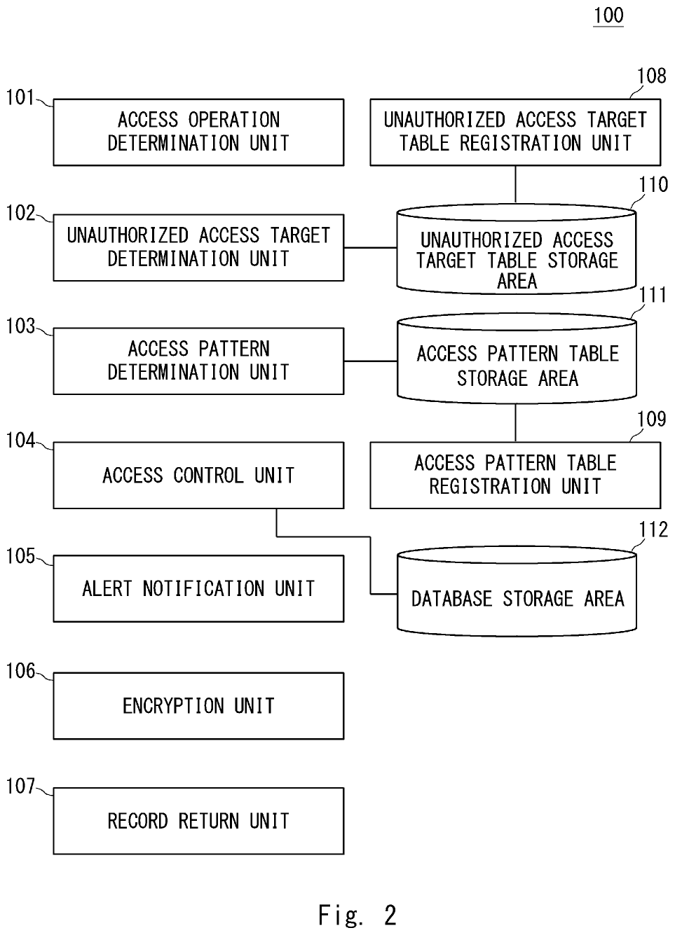

A database system 100 according to a first example embodiment of the present invention is described. FIG. 2 is a diagram showing one example of the database system 100 according to the first example embodiment. As shown in FIG. 2, the database system 100 includes an access operation determination unit 101, an unauthorized access target determination unit 102 as unauthorized access target determination means, an access pattern determination unit 103 as access pattern determination means, an access control unit 104 as access control means, an alert notification unit 105 as alert notification means, an encryption unit 106 as encryption means, a record return unit 107, an unauthorized access target table registration unit 108 as unauthorized access target information registration means, an access pattern table registration unit 109 as access pattern information registration means, an unauthorized access target table storage area 110 as unauthorized access target information storage means, an access pattern table storage area 111 as access pattern information storage means, a database storage area 112 as a database and the like.

When there is an access request to data stored in the database storage area 112 of the database system 100, the access operation determination unit 101 determines whether the access request is an access request to perform a reference process, or an access request to perform an update process. Specifically, the access operation determination unit 101 determines whether the access request is the access request to perform the reference process or the access request to perform the update process, based on information included in the access request.

When it is determined that the access request is the access request to perform the update process by the access operation determination unit 101, the following process is performed by the access control unit 104.

When it is determined that the access request is the access request to perform the reference process by the access operation determination unit 101, the unauthorized access target determination unit 102 compares information included in the access request, and an unauthorized access target table (unauthorized access target information) stored in the unauthorized access target table storage area 110. Subsequently, the unauthorized access target determination unit 102 determines whether or not the access request is an access request to an unauthorized access target data. Here, the unauthorized access target data is a data that is stored in the database storage area 112 and requires protection from unauthorized access. Further, the unauthorized access target table is a table in which information concerning the unauthorized access target data is summarized. Specifically, the unauthorized access target table is a table in which a data name and the like of the unauthorized access target data are summarized. Note that registration of the unauthorized access target table to the unauthorized access target table storage area 110 is performed by the unauthorized access target table registration unit 108. Details of a registration process of the unauthorized access target table to the unauthorized access target table storage area 110 by the unauthorized access target table registration unit 108 are described later.

The access pattern determination unit 103 compares information included in the access request and an access pattern table stored in the access pattern table storage area 111, when it is determined that the above-described access request is the access request to the unauthorized access target data by the unauthorized access target determination unit 102. Subsequently, the access pattern determination unit 103 determines whether or not the access request is unauthorized access. Here, the access pattern table is information concerning an access pattern to the unauthorized access target data by a user having access authority to the unauthorized access target data. Specifically, the access pattern table is a table in which names of users having access authority to the unauthorized access target data, data names of the unauthorized access target data, access times and dates and the like are summarized. Accordingly, when the information included in the access request and the information registered in the access pattern table stored in the access pattern table storage area 111 are different, the access pattern determination unit 103 determines that the access request is unauthorized access. Note that registration of the access pattern table to the access pattern table storage area 111 is performed by the access pattern table registration unit 109. Details of a registration process of the access pattern table to the access pattern table storage area 111 by the access pattern table registration unit 109 are described later.

When it is determined that the above-described access request is not unauthorized access by the access pattern determination unit 103, the access control unit 104 provides the unauthorized access target data which the access request desires to access to the user. Specifically, when the access request is not unauthorized access, the access control unit 104 obtains the unauthorized access target data (record) which the access request desires to access from the database storage area 112 and transfers the unauthorized access target data to the record return unit 107.

Further, when it is determined that the access request is the access request to perform the update process by the access operation determination unit 101, the access control unit 104 similarly obtains the unauthorized access target data (record) from the database storage area 112 and transfers the unauthorized access target data to the record return unit 107.

Furthermore, when it is determined that the aforementioned access request is unauthorized access by the access pattern determination unit 103, the access control unit 104 obtains the unauthorized access target data (record) which the access request desires to access from the database storage area 112 and transfers the unauthorized access target data to the encryption unit 106.

When it is determined that the aforementioned access request is unauthorized access by the access pattern determination unit 103, the alert notification unit 105 performs an alert notification to a predetermined notification destination.

When it is determined that the above-described access request is unauthorized access by the access pattern determination unit 103, the encryption unit 106 encrypts the unauthorized access target data which the access request desires to access. Specifically, when the access request is unauthorized access, the access control unit 104 obtains the unauthorized access target data (record) which the access request desires to access. Subsequently, the encryption unit 106 encrypts the unauthorized access target data which the access request desires to access and which is transferred from the access control unit 104. Further, the encryption unit 106 transfers the encrypted unauthorized access target data to the record return unit 107.

When it is determined that the above-described access request is not unauthorized access by the access pattern determination unit 103, the record return unit 107 provides the unauthorized access target data which the access request desires to access, to the user. Specifically, when the access request is not unauthorized access, the access control unit 104 obtains the unauthorized access target data (record) which the access request desires to access. Subsequently, the record return unit 107 provides the unauthorized access target data transferred from the access control unit 104, to the user.

Further, when it is determined that the access request is an access request to perform the update process by the access operation determination unit 101, the record return unit 107 similarly provides the unauthorized access target data which the access request desires to access, to the user.

Furthermore, when it is determined that the above-described access request is unauthorized access by the access pattern determination unit 103, the record return unit 107 provides the unauthorized access target data that is encrypted by the encryption unit 106, to the user. Specifically, when the access request is not unauthorized access, the access control unit 104 obtains the unauthorized access target data (record) which the access request desires to access. Next, the encryption unit 106 encrypts the unauthorized access target data that is transferred from the access control unit 104. Subsequently, the record return unit 107 provides the encrypted unauthorized access target data that is transferred from the encryption unit 106, to the user.

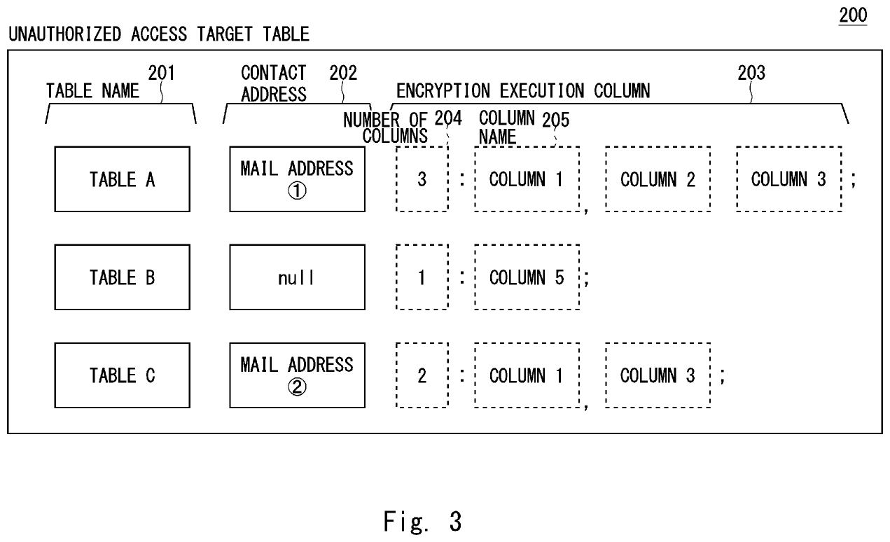

The unauthorized access target table registration unit 108 registers an unauthorized access target table in the unauthorized access target table storage area 110. Here, the unauthorized access target table is a table in which information concerning unauthorized target data is summarized. One example of an unauthorized access target table 200 that is registered in the unauthorized access target table storage area 110 is shown in FIG. 3. The unauthorized access target table 200 is a table in which a data name (table name) 201 of unauthorized access target data, a contact address 202, and an encryption execution column 203 are associated as shown in FIG. 3, for example. Further, the encryption execution column 203 is information in which the number 204 of columns, and a column name 205 are associated. Details of a registration process of the unauthorized access target table 200 into the unauthorized access target table storage area 110 by the unauthorized access target table registration unit 108 are described later.

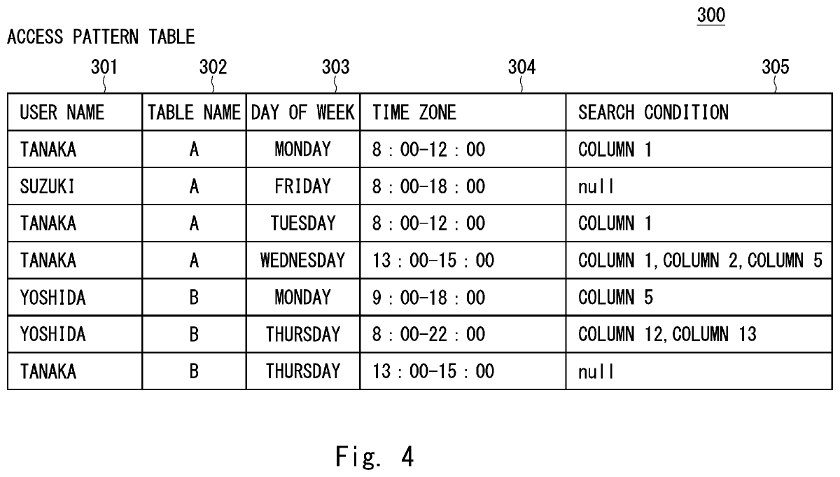

The access pattern table registration unit 109 registers an access pattern table in the access pattern table storage area 111. Here, the access pattern table is information concerning an access pattern of a user having access authority to unauthorized access target data, to the unauthorized access target data. One example of an access pattern table 300 that is registered in the access pattern table storage area 111 is shown in FIG. 4. The access pattern table 300 is a table in which a name (user name) 301 of a user having access authority to unauthorized access target data, a data name (table name) 302 of the unauthorized access target data, a day 303 of week of access, a time zone 304 of access, and a search condition 305 are associated as shown in FIG. 4, for example. Details of a registration process of the access pattern table 300 to the access pattern table storage area 111 by the access pattern table registration unit 109 are described later.

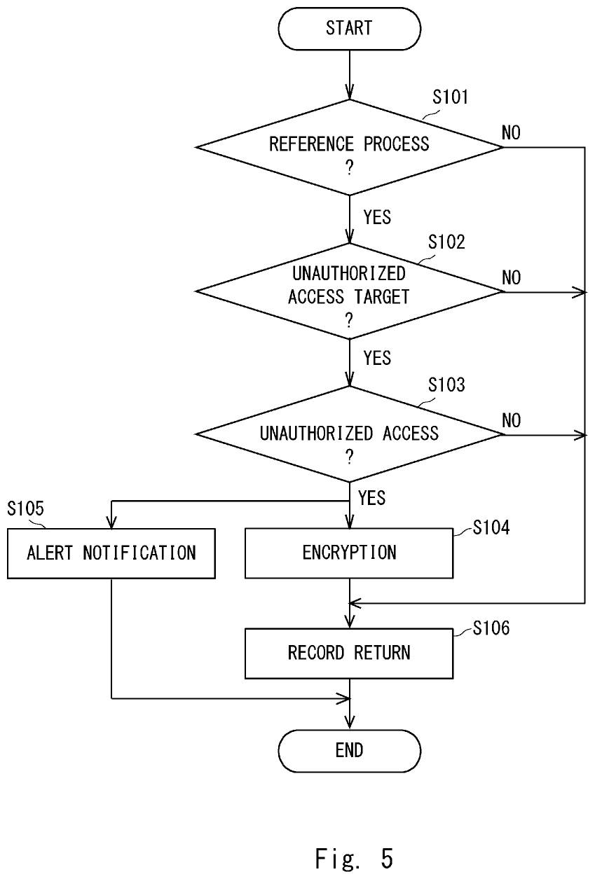

Next, a database management method in the database system 100 according to the present first example embodiment is described with reference to FIG. 5.

First, as shown in FIG. 5, when there is an access request to the data stored in the database storage area 112 of the database system 100, the access operation determination unit 101 determines whether the access request is an access request to perform the reference process, or an access request to perform the update process (step S101).

When it is determined that the access request is the access request to perform the update process by the access operation determination unit 101 in step S101 (step S101; No), the flow proceeds to a process in step S106.

When it is determined that the access request is the access request to perform the reference process by the access operation determination unit 101 in step S101 (step S101; Yes), the unauthorized access target determination unit 102 determines whether or not the access request is an access request to the unauthorized access target data (step S102). Specifically, the unauthorized access target determination unit 102 compares a data name (table name) of a data which the access request desires to access, and the table name 201 registered in the unauthorized access target table 200 shown in FIG. 3. Subsequently, when the table name of the data which the access request desires to access corresponds to the table name 201 registered in the unauthorized access target table 200, for example, the unauthorized access target determination unit 102 determines that the access request is the access request to the unauthorized access target data.

When it is determined that the access request is not the access request to the unauthorized access target data by the unauthorized access target determination unit 102 in step S102 (step S102; No), the flow proceeds to the process in step S106.

When it is determined that the access request is the access request to the unauthorized access target data by the unauthorized access target determination unit 102 in step S102 (step S102; Yes), the access pattern determination unit 103 determines whether or not the access request is unauthorized access (step S103). For example, the access pattern determination unit 103 searches the access pattern table 300 shown in FIG. 4 based on a name of a person who executes the access request, a table name of the data which the access request desires to access, and a day of week of access. Next, the access pattern determination unit 103 obtains the time zone 304 of access with a name, a table name and a day of week corresponding to the name, the table name and the day of week, and the search condition 305 from the access pattern table 300 shown in FIG. 4. Subsequently, when the time at which the access request is executed and the search condition included in the access request do not correspond to the time zone 304 of the access and the search condition 305 that are obtained from the access pattern table 300 shown in FIG. 4, the access pattern determination unit 103 determines that the access request is unauthorized access.

When it is determined that the access request is not unauthorized access by the access pattern determination unit 103 in step S103 (step S103; No), the flow proceeds to the process in step S106.

When it is determined that the access request is unauthorized access by the access pattern determination unit 103 in step S103 (step S103; Yes), the encryption unit 106 encrypts the unauthorized access target data which the access request desires to access (step S104). Specifically, when the access request is unauthorized access, the access control unit 104 obtains the unauthorized access target data (record) which the access request desires to access. Subsequently, the encryption unit 106 encrypts the unauthorized access target data which the access request desires to access and which is transferred from the access control unit 104. Further, the encryption unit 106 transfers the encrypted unauthorized access target data to the record return unit 107, and the flow proceeds to step S106.

Further, when it is determined that the access request is unauthorized access by the access pattern determination unit 103 in step S103 (step S103; Yes), the alert notification unit 105 performs an alert notification to a predetermined notification destination (step S105). Specifically, the alert notification unit 105 performs a predetermined alert notification to the contact address 202 that is registered in the unauthorized access target table 200 shown in FIG. 3.

Next, the record return unit 107 provides the data which the access request desires to access or the encrypted unauthorized access target data, to a user (step S106).

Specifically, the data which the access request desires to access is provided to the user, when the access request is the access request to perform the update process (step S101; No), when the access request is not the access request to the unauthorized access target data (step S102; No), and when the access request is not unauthorized access (step S103; No).

Further, when the access request is unauthorized access (step S103; Yes), the unauthorized access target data that is encrypted in step S104 is provided to the user.

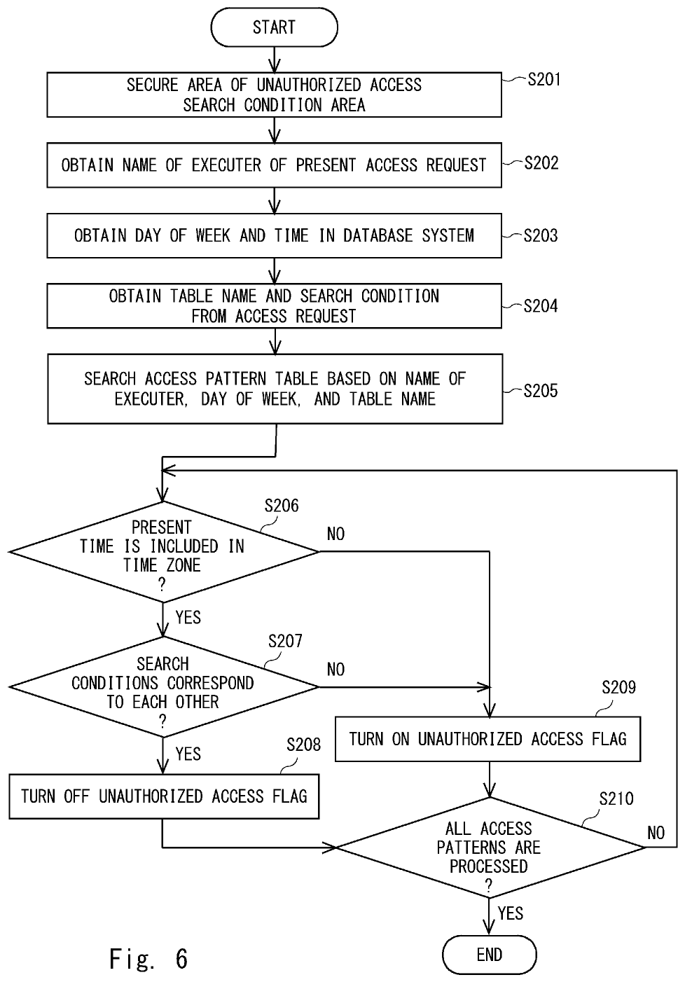

Next, an unauthorized access detection process in step S103 in FIG. 5 is described in detail with reference to FIG. 6.

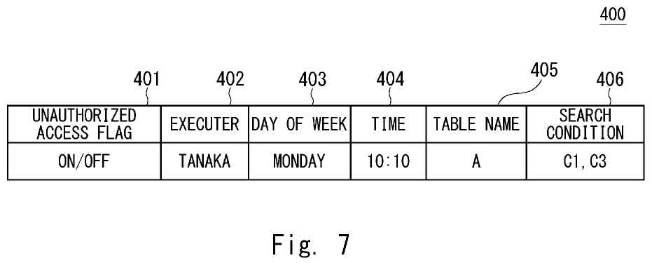

First, as shown in FIG. 6, the access pattern determination unit 103 secures an area of an unauthorized access search condition area 400 in a memory (storage unit) of the database system 100 (step S201). One example of the unauthorized access search condition area 400 is shown in FIG. 7. The unauthorized access search condition area 400 is an area for registering a table in which an unauthorized access flag 401, a name (executer) 402 of a person who executes an access request, a day 403 of week on which the access request is executed, a time 404 at which the access request is executed, a table name 405 of a data which the access request desires to access, and a search condition 406 are associated, as shown in FIG. 7.

Next, the access pattern determination unit 103 obtains a name of a person who executes the access request, and registers the name in a column of the executer 402 of the unauthorized access search condition area 400 (step S202).

Next, the access pattern determination unit 103 registers a present day of week and time that are counted in the database system 100, in the day 403 of week and the time 404 of the unauthorized access search condition area 400 respectively (step S203).

Next, the access pattern determination unit 103 obtains a table name of a data which the access request desires to access and which is included in the access request, and a search condition (the number of columns and a column name), and registers the table name of the data and the search condition in the table name 405 and the search condition 406 of the unauthorized access search condition area 400 respectively (step S204).

Next, the access pattern determination unit 103 searches the access pattern table 300 stored in the access pattern table storage area 111 based on the executer 402, the table name 405, and the search condition 406 that are registered in the unauthorized access search condition area 400 (step S205).

Next, the access pattern determination unit 103 determines whether or not the time 404 that is registered in the unauthorized access search condition area 400 is included in the time zone 304 of the access pattern that is searched for in step S205 (step S206).

When the time 404 registered in the unauthorized access search condition area 400 is not included in the time zone 304 of the access pattern that is searched for in step S205, in step S206 (step S206; No), the flow proceeds to a process in step S209.

When the time 404 registered in the unauthorized access search condition area 400 is included in the time zone 304 of the access pattern that is searched for in step S205, in step S206 (step S206; Yes), the access pattern determination unit 103 determines whether or not the search condition 305 of the access pattern that is searched for in step S205 and the search condition 406 registered in the unauthorized access search condition area 400 correspond to each other (step S207).

When the search condition 305 of the access pattern that is searched for in step S205 and the search condition 406 registered in the unauthorized access search condition area 400 do not correspond to each other in step S207 (step S207; No), the flow proceeds to the process in step S209.

When the search condition 305 of the access pattern that is searched for in step S205 and the search condition 406 registered in the unauthorized access search condition area 400 correspond to each other in step S207 (step S207; Yes), the access pattern determination unit 103 turns off the access flag 401 of the unauthorized access search condition area 400 (step S208) and proceeds to a process in step S210.

In the case of No in step S206, and in the case of No in step S207, the access pattern determination unit 103 turns on the unauthorized access flag 401 of the unauthorized access search condition area 400 (step S209), and proceeds to the process in step S210.

Next, the access pattern determination unit 103 determines whether or not the processes in steps S206, S207 and S208, or the processes in steps S206, S207 and S209 are performed with respect to all the access patterns that are searched for in step S205 (step S210).

When the processes in step S206, S207 and S208, or the processes in steps S206, S207 and S209 are not performed with respect to all the access patterns that are searched for in step S205, in step S210 (step S210; No), the flow returns to the process in step S206.

When the processes in step S206, S207 and S208, or the processes in steps S206, S207 and S209 are performed with respect to all the access patterns that are searched for in step S205, in step S210 (step S210; Yes), the present process is ended.

In other words, when the access pattern determination unit 103 turns off the unauthorized access flag 401 of the unauthorized access search condition area 400 in step S208, the access pattern determination unit 103 determines that the access request is not unauthorized access in step S103 in FIG. 5. On the other hand, when the access pattern determination unit 103 turns on the unauthorized access flag 401 of the unauthorized access search condition area 400 in step S209, the access pattern determination unit 103 determines that the access request is not unauthorized access in step S103 in FIG. 5.

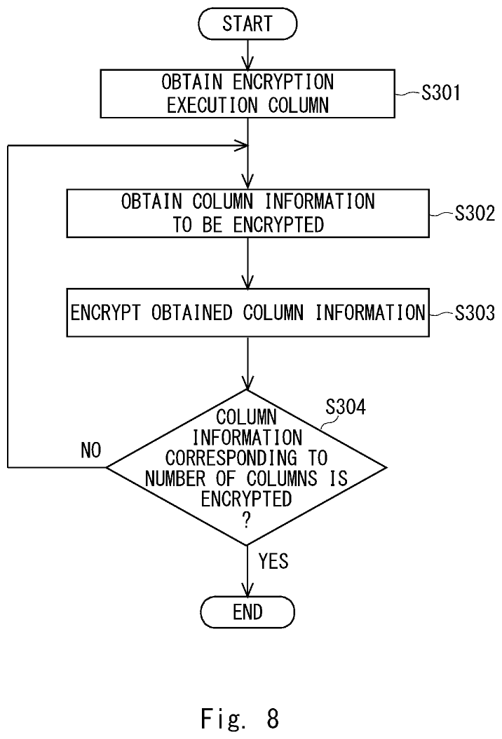

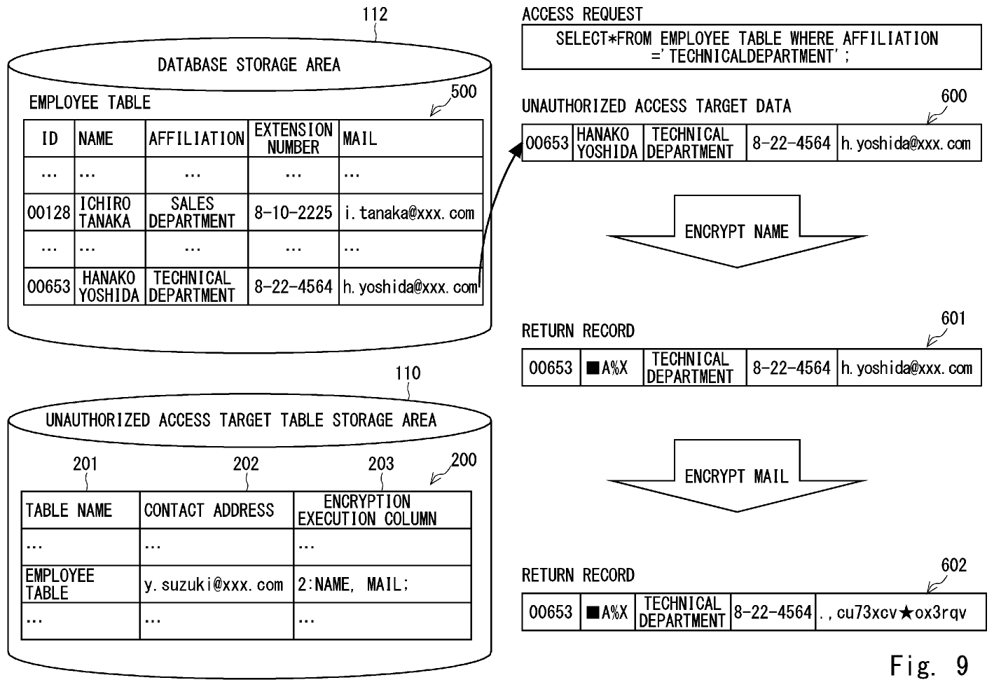

Next, the encryption process in step S104 in FIG. 5 is described in detail with reference to FIG. 8 and FIG. 9. FIG. 8 is a flowchart explaining the encryption process in step S104 in FIG. 5, and FIG. 9 is a diagram explaining one example of the encryption process.

In FIG. 9, an encryption process of data in a case of an access request being performed to the data of “Hanako Yoshida” belonging to a “Technical department” of an employee table 500 that is the data stored in the database storage area 112 is described as an example. In other words, FIG. 9 explains the encryption process when a SELECT sentence that is the access request to the database system 100 is “SELECT*FROM Employee table WHERE affiliation=‘Technical department’;”. In this case, the access control unit 104 obtains an unauthorized access target data 600 which the access request desires from the employee table 500, from the database storage area 112. As shown in FIG. 9, the unauthorized access target data 600 is a data in which “00653” that is an ID, “Hanako Yoshida” that is a name, the “Technical department” that is an affiliation, “8-22-4564” that is an extension number, and “h.yoshida@xxx.com” that is an e-mail address are associated. Subsequently, the access control unit 104 transfers the unauthorized access target data 600 to the encryption unit 106.

First, as shown in FIG. 8, the encryption unit 106 obtains the encryption execution column 203 from the unauthorized access target table 200 shown in FIG. 3, based on the table name included in the access request (step S301). In the example shown in FIG. 9, the encryption unit 106 obtains “2” that is the number 204 of columns, the “Name” that is the column name 205 and “Mail”, as the encryption execution column 203.

Next, the encryption unit 106 obtains column information to perform encryption of the unauthorized access target data 600 that is transferred from the access control unit 104, based on the number 204 of columns and the column name 205 that are obtained in step S301 (step S302). In the example shown in FIG. 9, the encryption unit 106 obtains column information “Hanako Yoshida” and column information “h.yoshida@xxx.com” that correspond to the “Name” that is the column name 205 and the “Mail” from the unauthorized access target data 600.

Next, the encryption unit 106 encrypts the column information obtained in step S302 (step S303). In the example shown in FIG. 9, after the column information “Hanako Yoshida” of the unauthorized access target data 600 is encrypted and a return record 601 is generated, the column information “h.yoshida@xxx.com” of the return record 601 is encrypted and a return record 602 is generated.

Next, the encryption unit 106 determines whether or not the column information of the number of the number 204 of columns that is obtained in step S301 is encrypted (step S304). In the example shown in FIG. 9, the encryption unit 106 determines whether or not the column information corresponding to “2” that is the number 204 of columns obtained in step S301 is encrypted.

When the column information corresponding to the number of the number 204 of columns obtained in step S301 is not encrypted, in step S304 (step S304; No), the flow returns to a process in step S302.

When the column information corresponding to the number in the number 204 of columns obtained in step S301 is encrypted, in step S304 (step S304; Yes), the present process is ended.

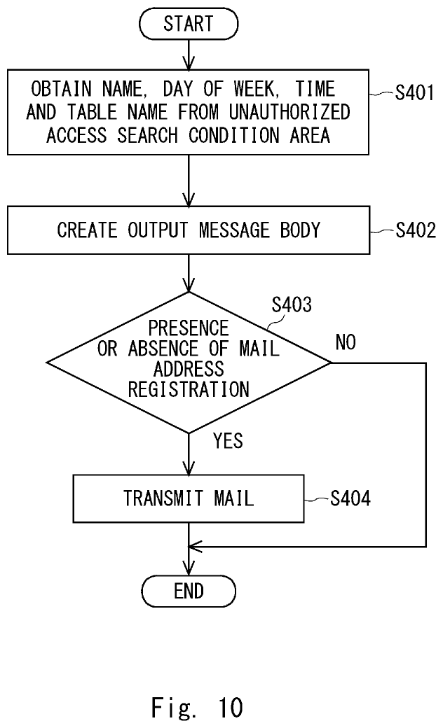

Next, an alert notification process in step S105 in FIG. 5 is described in detail with reference to FIG. 10.

First, the alert notification unit 105 obtains information such as the name (executer) 402 of a person who executes an access request, the day 403 of week on which the access request is executed, the time 404 at which the access request is executed, and the table name 405 of the data which the access request desires to access, from the unauthorized access search condition area 400 (step S401).

Next, the alert notification unit 105 creates an output message body based on the information obtained in step S401 (step S402).

Next, the alert notification unit 105 searches the unauthorized access target table 200 based on the table name 405 obtained in step S401 and determines whether or not a mail address is registered as the contact address 202 (step S403).

When a mail address is not registered as the contact address 202 in step S403 (step S403; No), the present process is ended.

When a mail address is registered as the contact address 202 in step S403 (step S403; Yes), the message body created in step S402 is emailed to the main address (step S404).

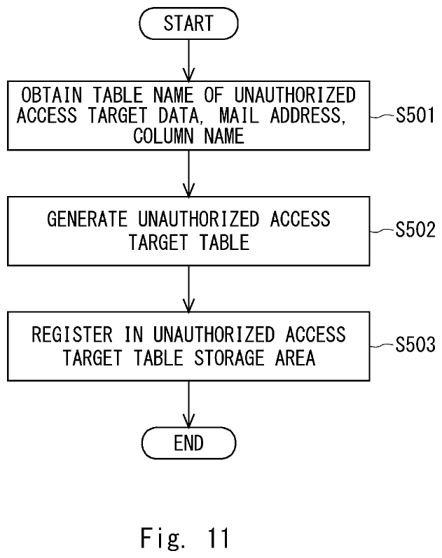

Next, a registration process of the unauthorized access target table 200 to the database system 100 according to the present first example embodiment is described in detail with reference to FIG. 11.

First, the unauthorized access target table registration unit 108 defines an unauthorized access target table in the unauthorized access target table storage area 110 of the database system 100, and thereafter, obtains the table name of the unauthorized access target data, a mail address, and the column name of the column information that should be protected (step S501). Note that a column number may be obtained instead of the column name. Further, instead of a column number continuous from a first column number to a second column number, the first column number, a hyphen “-” between the first column number and the second column number, and the second column number may be obtained. Further, when it is necessary to protect all pieces of column information, “*” that means all pieces of column information may be obtained, instead of all column names or column numbers. Furthermore, the column names and the column numbers may be mixedly obtained.

Next, the unauthorized access target table registration unit 108 generates the unauthorized access target table based on the information obtained in step S501 (step S502).

Next, the unauthorized access target table registration unit 108 registers the unauthorized access target table generated in step S502 in the unauthorized access target table storage area 110 as the unauthorized access target table 200 (step S503).

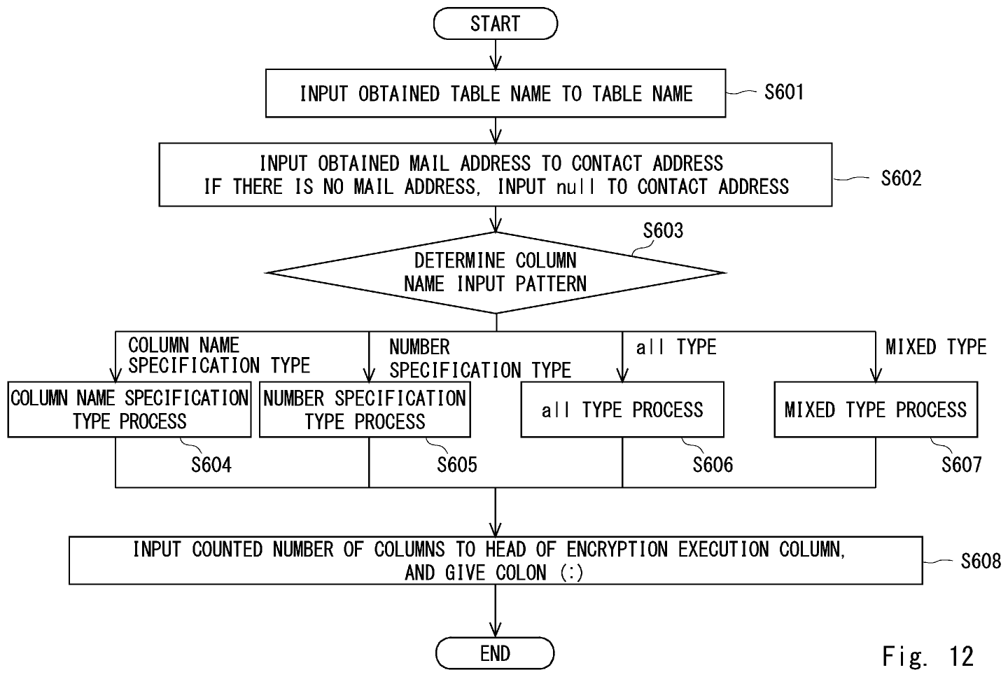

Next, a generation process of the unauthorized access target table 200 in step S502 in FIG. 11 is described in detail with reference to FIG. 12.

First, the unauthorized access target table registration unit 108 inputs the table name obtained in step S501 to the table name 201 of the unauthorized access target table 200 (step S601).

Next, the unauthorized access target table registration unit 108 inputs the mail address obtained in step S501 to the contact address 202 of the unauthorized access target table 200, and when the mail address is not obtained in step S501, the unauthorized access target table registration unit 108 inputs “null” to the contact address 202 (step S602).

Next, the unauthorized access target table registration unit 108 determines the input pattern of the column name 205 of the encryption execution column 203 of the unauthorized access target table 200 (step S603). Here, as the input pattern of the column name 205, a column name specification type, a number specification type, an all type, and a mixed type are cited, for example.

When the input pattern of the column name 205 is a column name specification type in step S603, the unauthorized access target table registration unit 108 performs a column name specification type process (step S604). Specifically, the unauthorized access target table registration unit 108 inputs the column name obtained in step S501 to the column name 205 of the encryption execution column 203 of the unauthorized access target table 200. Note that when the unauthorized access target table registration unit 108 obtains a plurality of column names in step S501, the unauthorized access target table registration unit 108 gives a comma “,” between the adjacent column name 205 and column name 205 and gives a semicolon “;” after the last column name 205, in the unauthorized access target table 200.

When the input pattern of the column name 205 is a number specification type in step S603, the unauthorized access target table registration unit 108 performs a number specification type process (step S605). Specifically, the unauthorized access target table registration unit 108 converts the column number obtained in step S501 into a column name and inputs the converted column name to the column name 205 of the encryption execution column 203 of the unauthorized access target table 200. Further, when the first column number, the hyphen “-” between the first column number and the second column number, and the second column number are obtained in step S501, the unauthorized access target table registration unit 108 converts all the column numbers from the first column number to the second column number into column names, and inputs the converted column names to the column name 205 of the encryption execution column 203 of the unauthorized access target table 200. Note that the unauthorized access target table registration unit 108 gives a comma “,” between the adjacent column name 205 and column name 205 and gives a semicolon “;” after the last column name 205, in the unauthorized access target table 200.

When the input pattern of the column name 205 is an all type in step S603, the unauthorized access target table registration unit 108 performs an all type process (step S606). Specifically, the unauthorized access target table registration unit 108 obtains all the column names of the unauthorized access target data stored in the database storage area 112, and inputs all the obtained column names to the column name 205 of the encryption execution column 203 of the unauthorized access target table 200. Note that the unauthorized access target table registration unit 108 gives a comma “,” between the adjacent column name 205 and column name 205 and gives a semicolon “;” after the last column name 205, in the unauthorized access target table 200.

When the input pattern of the column name 205 is a mixed type in step S603, the unauthorized access target table registration unit 108 performs the processes in step S604 and step S605 (step S607).

Next, the unauthorized access target table registration unit 108 counts the number of the column names 205 inputted to the encryption execution column 203 of the unauthorized access target table 200, inputs the counted number to the number 204 of columns of the encryption execution column 203 of the unauthorized access target table 200, and gives a colon “:” after the number 204 of columns (step S608).

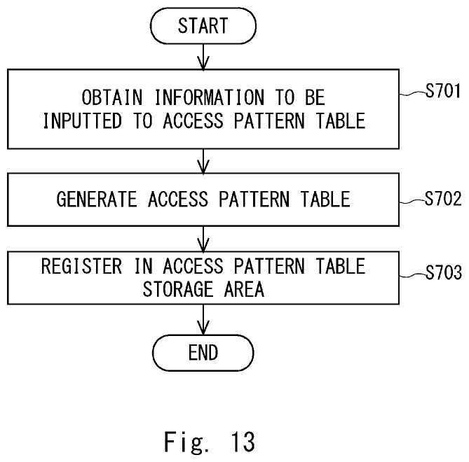

Next, a registration process of the access pattern table 300 to the database system 100 according to the present first example embodiment is described in detail with reference to FIG. 13.

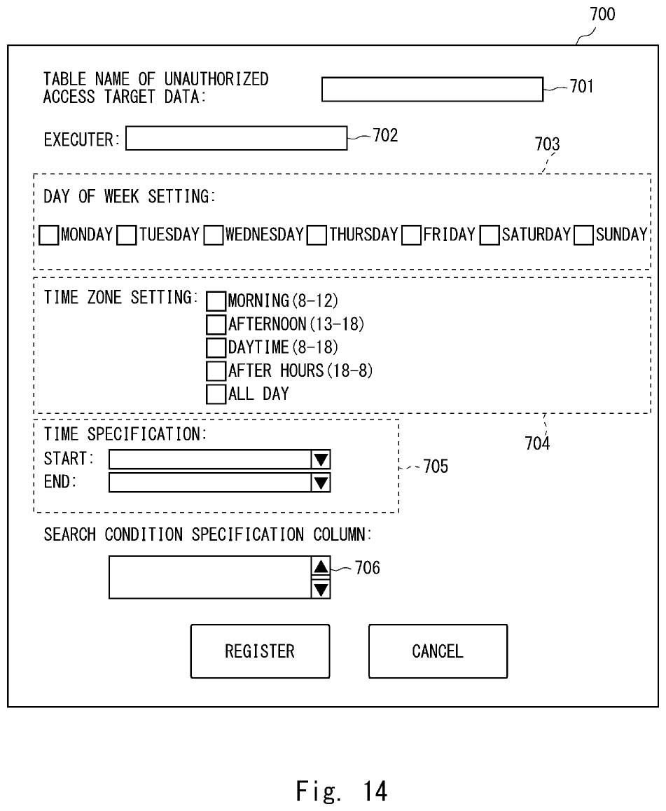

First, the access pattern table registration unit 109 defines an access pattern table in the access pattern table storage area 111 of the database system 100, and thereafter, obtains information that should be inputted to the access pattern table (step S701). Specifically, the access pattern table registration unit 109 displays an input form 700 shown in FIG. 14, for example, on a display unit (not illustrated) of the database system 100 and a display unit (not illustrated) of a user terminal. Subsequently, the access pattern table registration unit 109 obtains information that is inputted by a user by using the input form 700 as the information that should be inputted to the access pattern table.

Next, the access pattern table registration unit 109 generates the access pattern table based on the information obtained in step S701 (step S702).

Next, the access pattern table registration unit 109 registers the access pattern table generated in step S702 to the access pattern table storage area 111 as the access pattern table 300 (step S703).

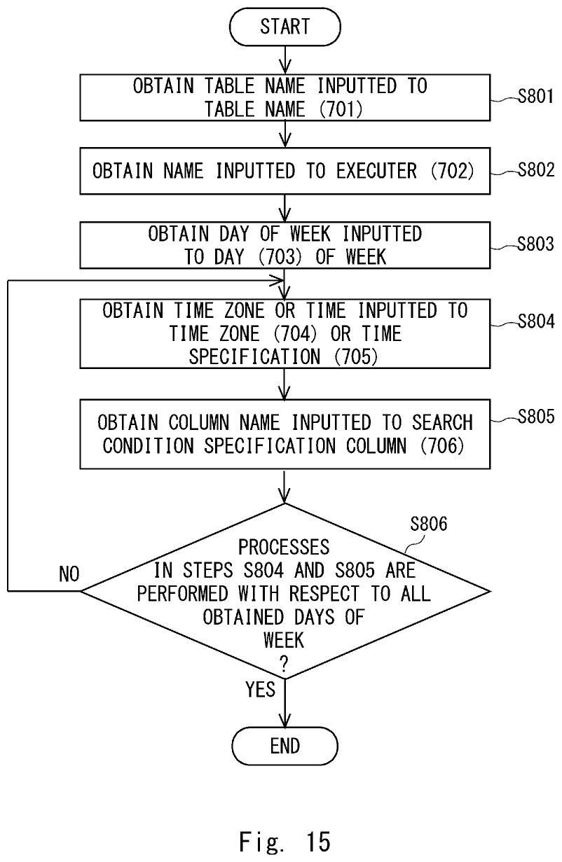

Next, an obtainment process of the information that should be inputted to the access pattern table 300 in step S701 in FIG. 13 is described in detail with reference to FIG. 15.

First, the access pattern table registration unit 109 obtains a table name inputted to a table name 701 of the unauthorized access target data of the input form 700 as the table name 302 of the access pattern table 300 (step S801).

Next, the access pattern table registration unit 109 obtains a name that is inputted to an executer 702 of the input form 700 as the user name 301 of the access pattern table 300 (step S802).

Next, the access pattern table registration unit 109 obtains days of week that are inputted to a day 703 of week of the input form 700 as the day 303 of week of the access pattern table 300 (step S803). Note that in the day 703 of week of the input form 700, check boxes that respectively allow Monday to Sunday to be selected are provided. In the day 703 of week of the input form 700, a user can input a plurality of days of week by selecting a plurality of check boxes.

Next, the access pattern table registration unit 109 obtains a time zone inputted to a time zone setting 704 of the input form 700 or a start time and an end time that are inputted to a time specification 705 as the time zone 304 of the access pattern table 300 (step S804). Specifically, the access pattern table registration unit 109 converts a start time and an end time of the time zone that is inputted to the time zone setting 704 of the input form 700 into a start matter and an end time of the time zone 304 of the access pattern table 300. Further, the access pattern table registration unit 109 obtains the start time and the end time that are inputted to the time specification 705 of the input form 700 as the start matter and the end time of the time zone 304 of the access pattern table 300. Note that in the time zone setting 704 of the input form 700, there are provided, for example, check boxes that respectively allow time zones such as morning (8:00 to 12:00), afternoon (13:00 to 18:00), daytime (8:00 to 18:00), after hours (18:00 to 8:00), and all day to be selected. Further, in the time specification 705, the start time and the end time can be specified by pulling down.

Next, the access pattern table registration unit 109 obtains a column name that is inputted to a search condition specification column 706 of the input form 700 as the search condition 305 of the access pattern table 300 (step S805).

Next, the access pattern table registration unit 109 determines whether or not the processes in step S804 and step S805 are performed with respect to all days of week that are obtained in step S803 (step S806).

When the processes in step S804 and step S805 are not performed with respect to all the days of week that are obtained in step S803, in step S806 (step S806; No), the flow returns to the process in step S804.

When the processes in step S804 and step S805 are performed with respect to all the days of week obtained in step S803, in step S806 (step S806; Yes), the present process is ended.

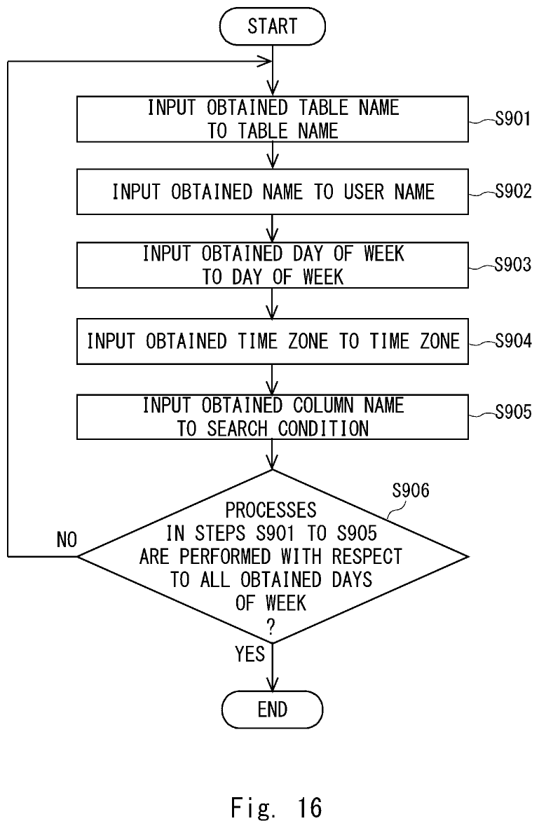

Next, the generation process of the access pattern table in step S702 in FIG. 13 is described in detail with reference to FIG. 16.

First, the access pattern table registration unit 109 inputs the table name obtained in step S801 to the table name 302 of the access pattern table 300 (step S901).

Next, the access pattern table registration unit 109 inputs the name obtained in step S802 to the user name 301 of the access pattern table 300 (step S902).

Next, the access pattern table registration unit 109 inputs the days of week obtained in step S803 to the day 303 of week of the access pattern table 300 (step S903).

Next, the access pattern table registration unit 109 inputs the time zone obtained in step S804 to the time zone 304 of the access pattern table 300 (step S904).

Next, the access pattern table registration unit 109 inputs the column name obtained in step S805 to the search condition 305 of the access pattern table 300 (step S905). Note that when the column name is not obtained in step S805, the access pattern table registration unit 109 inputs “null” to the search condition 305 of the access pattern table 300.

Next, the access pattern table registration unit 109 determines whether the processes in step S901 to step S905 are performed with respect to all the days of week that are obtained in step S803 (step S906).

When the processes in step S901 to step S905 are not performed with respect to all the days of the week that are obtained in step S803, in step S906 (step S906; No), the flow returns to a process in step S901.

When the processes in step S901 to step S905 are performed with respect to all the days of week that are obtained in step S803, in step S906 (step S906; Yes), the present process is ended.

According to the database system 100 according to the present first example embodiment described above, when there is an access request to the database storage area 112 of the database system 100, it is determined whether or not the access request is unauthorized access by the access pattern determination unit 103. Further, when it is determined that the access request is unauthorized access by the access pattern determination unit 103, an alert notification is performed to a predetermined notification destination by the alert notification unit 105. Therefore, it is possible to detect unauthorized access more quickly than detecting the unauthorized access after checking access log information after the fact. Further, when data is stored in the database storage area 112 of the database system 100, it is not necessary to divide the data, and therefore, the process steps at the times of storage, update and reference of the data can be decreased more. Thereby, the database system 100 that can detect unauthorized access more quickly with the simpler process steps can be provided.

Further, when it is determined that the access request is unauthorized access by the access pattern determination unit 103, the unauthorized access target data which the access request desires to access is encrypted by the encryption unit 106. Therefore, the unauthorized access target data that should be protected from unauthorized access can be more reliably protected.

Further, since the unauthorized access target table 200 is registered in the unauthorized access target table storage area 110 by the unauthorized access target table registration unit 108, information concerning the unauthorized access target data that should be protected is managed as the unauthorized access target table 200. Therefore, protection of the unauthorized access target data can be performed more smoothly by using the unauthorized access target table 200. Specifically, by using the unauthorized access target table 200, it is possible to determine whether or not an access request is the access request to the unauthorized access target data. Further, it becomes possible to perform an alert notification to the contact address 202 that is registered in the unauthorized access target table 200. Further, it becomes possible to encrypt necessary information columns of the unauthorized access target data by referring to the encryption execution column 203 of the unauthorized access target table 200.

Further, the access pattern table 300 is registered in the access pattern table storage area 111 by the access pattern table registration unit 109. Therefore, registration of the access pattern of the user who has the access authority to the unauthorized access target data that should be protected becomes easy. Further, it becomes possible to determine whether or not the access request is unauthorized access, by using the information concerning the access pattern.

Further, since the access pattern table registration unit 109 provides the input form for a user to input the information to be registered in the access pattern table, the user can easily input the information to be registered in the access pattern table by using the input form.

In the aforementioned example embodiment, the present invention is described as a configuration of hardware, but the present invention is not limited to this. In the present invention, it is also possible to realize processing procedures described in the flowcharts in FIGS. 5, 6, 8, 10, 11, 12, 13, 15 and 16 by causing a CPU (Central Processing Unit) to execute a computer program.

Further, the aforementioned program is stored by using various types of non-transitory computer-readable media (non-transitory computer readable media) and can be supplied to computers. The non-transitory computer-readable media includes various types of tangible storage media (tangible storage media). Examples of the non-transitory computer-readable media include magnetic storage media (for example, a flexible disk, a magnetic tape, and a hard disk drive), magneto-optical storage media (for example, a magneto-optical disk), a CD-ROM (Read Only Memory), a CD-R, a CD-R/W, and semiconductor memories (for example, a mask ROM, a PROM (Programmable ROM), an EPROM (Erasable PROM), a flash ROM, and a RAM (Random Access Memory)). Further, the program may be supplied to computers by various types of transitory computer-readable media (transitory computer readable media). Examples of the transitory computer-readable media include electric signals, optical signals, and electromagnetic waves. The transitory computer-readable media can supply the program to computers via wire communication paths such as an electric wire and an optical fiber, or wireless communication paths.

The invention of the present application is described above with reference to the example embodiment, but the invention of the present application is not limited by the above explanation. Various changes that can be understood by a person skilled in the art can be made within the scope of the invention, to the configuration and details of the invention of the present application.

For example, in the table name 701 of the unauthorized access target data of the input form 700 shown in FIG. 14, the candidate list may be displayed by pulling down. Thereby, input errors can be suppressed as compared with the case of manual input. The access pattern table registration unit 109 may obtain the candidate list that is displayed by pulling down by referring to the table name 201 of the unauthorized access target table 200.

Further, in the executer 702 of the input form 700 shown in FIG. 14, the candidate list of the names of the users may be displayed by pulling down. Thereby, input errors can be suppressed as compared with the case of manual input. The names of the users who can access the database system 100 are registered in the database storage area 112 or the like in advance, and the access pattern table registration unit 109 may obtain the candidate list displayed by pulling down by referring to the database storage area 112.

Further, if the names of the users who can access the database system 100 are displayed as the candidate list by pulling down in the executer 702 of the input form 700, as described above, it may be rather complicated if there are many users of the database system 100. Thus, when the user specifies the predetermined table name 201 of the unauthorized access target table 200 in the table name 701 of the input form 700, the access pattern table registration unit 109 may search for users of the unauthorized access target data of the above described specified table name from the users who can access the database system 100, and may display a result of the search by pulling down in the executer 702 of the input form 700. Thereby, even when there are many users of the database system 100, the candidate list that is displayed by pulling down in the executer 702 of the input form 700 can be narrowed down to a minimum.

Further, only the reference process of the unauthorized access target data registered in the database system 100 is the target of the processes of step S102 to step S106 in FIG. 5, but the process other than the reference process to the unauthorized access target data may also be the target of the processes of step S102 to step S106. In this case, step S101 may be omitted in FIG. 5.

Furthermore, in FIG. 10, check of presence or absence of registration of the mail address in step S403 may be performed before the process in step S401.

### INDUSTRIAL APPLICABILITY

The database system, the database management method, and the non-transitory computer-readable medium storing the program that can detect unauthorized access more quickly with the simpler process steps can be provided.

### REFERENCE SIGNS LIST

100 DATABASE SYSTEM
101 ACCESS OPERATION DETERMINATION UNIT
102 UNAUTHORIZED ACCESS TARGET DETERMINATION UNIT (UNAUTHORIZED ACCESS TARGET DETERMINATION MEANS)
103 ACCESS PATTERN DETERMINATION UNIT (ACCESS PATTERN DETERMINATION MEANS)
104 ACCESS CONTROL UNIT (ACCESS CONTROL MEANS)
105 ALERT NOTIFICATION UNIT (ALERT NOTIFICATION MEANS)
106 ENCRYPTION UNIT (ENCRYPTION MEANS)
107 RECORD RETURN UNIT
108 UNAUTHORIZED ACCESS TARGET TABLE REGISTRATION UNIT (UNAUTHORIZED ACCESS TARGET INFORMATION REGISTRATION MEANS)
109 ACCESS PATTERN TABLE REGISTRATION UNIT (ACCESS PATTERN INFORMATION REGISTRATION MEANS)
110 UNAUTHORIZED ACCESS TARGET TABLE STORAGE AREA (UNAUTHORIZED ACCESS TARGET INFORMATION STORAGE MEANS)
111 ACCESS PATTERN TABLE STORAGE AREA (ACCESS PATTERN INFORMATION STORAGE MEANS)
112 DATABASE STORAGE AREA (DATABASE)

What is claimed is:

1. A database system comprising:
unauthorized access target information storage unit configured to store unauthorized access target information concerning an unauthorized access target data that is a data stored in a database and requires protection from unauthorized access;
access pattern information storage unit configured to store access pattern information concerning an access pattern to the unauthorized access target data by a user having access authority to the unauthorized access target data;
unauthorized access target determination unit configured to determine, when there is an access request to the data stored in the database, whether or not the access request is an access request to the unauthorized access target data, by comparing information included in the access request, and the unauthorized access target information stored in the unauthorized access target information storage unit;
access pattern determination unit configured to determine whether or not the access request is unauthorized access, by comparing information included in the access request, and the access pattern information stored in the access pattern information storage unit, when it is determined that the access request is the access request to the unauthorized access target data by the unauthorized access target determination unit;
access control unit configured to provide the unauthorized access target data to the user, when it is determined that the access request is not unauthorized access by the access pattern determination unit; and
alert notification unit configured to perform an alert notification to a predetermined notification destination, when it is determined that the access request is unauthorized access by the access pattern determination unit.

2. The database system according to claim 1, further comprising encryption unit configured to encrypt the unauthorized access target data when it is determined that the access request is unauthorized access by the access pattern determination unit.

3. The database system according to claim 1, further comprising unauthorized access target information registration unit configured to register the unauthorized access target information in the unauthorized access target information storage unit.

4. The database system according to claim 1, further comprising access pattern information registration unit configured to register the access pattern information in the access pattern information storage unit.

5. The database system according to claim 4, wherein the access pattern information registration unit provides an input form for the user to input the access pattern information.

6. A database management method, wherein
a database system
stores unauthorized access target information concerning an unauthorized access target data that is a data stored in a database and requires protection from unauthorized access,
stores access pattern information concerning an access pattern to the unauthorized access target data by a user having access authority to the unauthorized access target data,
determines, when there is an access request to the data stored in the database, whether or not the access request is an access request to the unauthorized access target data, by comparing information included in the access request, and the unauthorized access target information,
determines whether or not the access request is unauthorized access, by comparing information included in the access request, and the access pattern information, when it is determined that the access request is the access request to the unauthorized access target data,
provides the unauthorized access target data to the user when it is determined that the access request is not unauthorized access, and
performs an alert notification to a predetermined notification destination when it is determined that the access request is unauthorized access.

7. The database management method according to claim 6, wherein the database system encrypts the unauthorized access target data when it is determined that the access request is unauthorized access.

8. A non-transitory computer-readable medium storing a program causing
a database system to execute
a process of storing unauthorized access target information concerning an unauthorized access target data that is a data stored in a database and requires protection from unauthorized access,
a process of storing access pattern information concerning an access pattern to the unauthorized access target data by a user having access authority to the unauthorized access target data,
a process of determining, when there is an access request to the data stored in the database, whether or not the access request is an access request to the unauthorized access target data, by comparing information included in the access request, and the unauthorized access target information,
a process of determining whether or not the access request is unauthorized access, by comparing information included in the access request, and the access pattern information, when it is determined that the access request is the access request to the unauthorized access target data,
a process of providing the unauthorized access target data to the user when it is determined that the access request is not unauthorized access, and
a process of performing an alert notification to a predetermined notification destination when it is determined that the access request is unauthorized access.

9. The non-transitory computer-readable medium storing the program according to claim 8, causing the database system to execute a process of encrypting the unauthorized access target data when it is determined that the access request is unauthorized access.

10. The database management method according to claim 6, wherein the database system provides an input form for the user to input the access pattern information.

11. The non-transitory computer-readable medium storing the program according to claim 8, causing the database system to execute a process of providing an input form for the user to input the access pattern information.
